(19) United States
(12) Patent Application Publication
(10) Pub. No.: US 2015/0104029 A1
(43) Pub. Date: Apr. 16, 2015

(54) SYSTEM FOR CONTROLLING FAN NOISE

(71) Applicants: INVENTEC CORPORATION, Taipei City (TW); Inventec (Pudong) Technology Corporation, Shanghai (CN)

(72) Inventors: Yi-Lun CHENG, TAIPEI CITY (TW); Kuo-Chi TING, TAIPEI CITY (TW)

(73) Assignees: INVENTEC CORPORATION, Taipei City (TW); Inventec (Pudong) Technology Corporation, Shanghai (CN)

(21) Appl. No.: 14/230,009

(22) Filed: Mar. 31, 2014

(30) Foreign Application Priority Data
Oct. 14, 2013 (CN) 201310479646.8

(51) Int. Cl. H04R 3/00

(52) U.S. Cl. CPC H04R 3/002
USPC 381/71.3

(57) ABSTRACT

A system for controlling fan noise includes a fin, a fan, a sensor, a signal processing unit, and a speaker. The fin has a front side and a rear side opposite to the front side. The fan is disposed adjacent to the front side and has an airflow outlet, and the airflow outlet faces the front side. The sensor is disposed adjacent to the rear side and is used for receiving a sound signal made by the fan. After the signal processing unit receives the sound signal sent by the sensor, the signal processing unit provides an inversed phase signal by analysis and computation. The speaker is disposed adjacent to the rear side, for receiving and outputting the inversed phase signal provided by the signal processing unit, so as to offset the noise made by the fan.

### RELATED APPLICATIONS

This application claims priority to Chinese Application Serial Number 201310479646.8, filed Oct. 14, 2013, which is herein incorporated by reference.

### BACKGROUND

With the development of technologies, the efficiencies of electronics become better and better. However, in the meantime, the heat the electronics generate increases as well. In order to avoid overheating to damage electronics, fans used for helping dissipate heat is an important part of the electronics.

Fan noises may make people feel different levels of anxiety. If disturbed by fan noises for a long time, people may feel tired and the work performance may become lower. Even worse, fan noises may cause psychological and physical harm.

General fan noise control methods lower the noises mainly by specific structure design. The methods include specific structure design of shell shape, fan shape, vanes or ribs and soundproofing devices. However, the above methods have no significant effect on low-frequency noises. How to effectively eliminate low-frequency noises made by the fans is an important issue in the associated industries.

### SUMMARY

This disclosure provides a system for controlling fan noise.

In one embodiment, a system for controlling fan noise is provided. The system includes a fin, a fan, a sensor, a signal processing unit, and a speaker. The fin has a front side and a rear side opposite to the front side. The fan is disposed adjacent to the front side and has an airflow outlet, and the airflow outlet faces the front side. The sensor is disposed adjacent to the rear side and is used for receiving a sound signal made by the fan. The signal processing unit receives the sound signal sent by the sensor and analyzes the sound signal to compute an inversed phase signal. The speaker is disposed adjacent to the rear side and is used for receiving and outputting the inversed phase signal provided by the signal processing unit, so as to offset the noise made by the fan.

In one or more embodiments, a distance between the fan and the sensor is larger than a distance between the fan and the speaker.

In one or more embodiments, a distance between the sensor and the fin is larger than a distance between the speaker and the fin.

In one or more embodiments, the sound signal is a mixed signal of a sound made by the fan and a sound made by the speaker.

In one or more embodiments, the speaker and the sensor are separated to assure that the mixed signal is thoroughly mixed by the sound made by the fan and the sound made by the speaker.

In one or more embodiments, the fin is columnar and has a long edge, and the front side and the rear side are respectively disposed at both ends of the long edge.

In one or more embodiments, the speaker is disposed outside an imaginary column extended from of the fin, and the speaker neighbors the rear side.

In one or more embodiments, the fan outputs an airflow along an airflow output direction, the speaker outputs the inversed phase signal along a sound direction, and the airflow output direction is perpendicular to the sound direction.

In one or more embodiments, the system further includes a motherboard. The motherboard has a central processing unit, and the fin thermally contacts with the central processing unit.

In one or more embodiments, the fan has a rotation speed detection module for providing the signal processing unit a fan rotation speed signal as a reference signal for analyzing and computing the inversed phase signal.

By properly designing the relative positions of the fan, the fin, the sensor, and the speaker, the fan can effectively dissipate the heat generated by the central processing unit through the fin. In the meantime, because the fin guides the airflow and the noise, the speaker and the sensor are disposed adjacent to the rear side of the fin, which is the leeward side, so that the system can effectively eliminates the noises made by the fan.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 is a schematic perspective view of the system for controlling fan noise according to one embodiment of this invention;

FIG. 2A is a block diagram of the system according to one embodiment of this invention;

FIG. 2B is a block diagram of the system according to another embodiment of this invention;

FIG. 3 is another perspective view of the system according to one embodiment of this invention; and

FIG. 4 is a perspective view of the system installed in a personal computer according to one embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

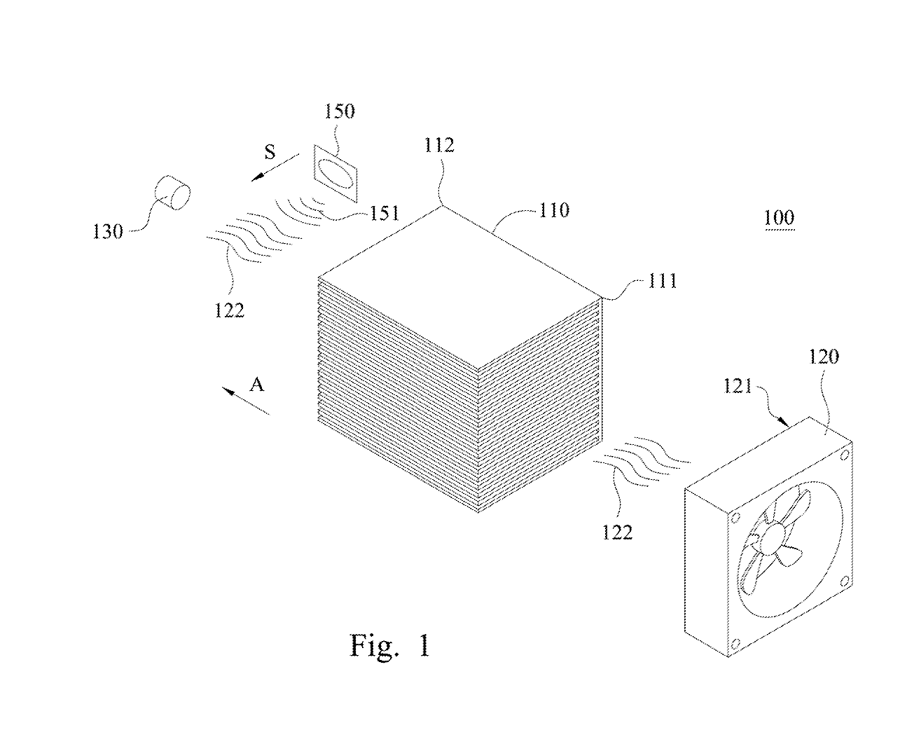

FIG. 1 is a schematic perspective view of the system for controlling fan noise according to one embodiment of this invention. A system 100 for controlling fan noise is provided. The system 100 is a fan module. The fan module can be installed in the personal computer or the server host and can be used for dissipating heat generated by a central processing unit.

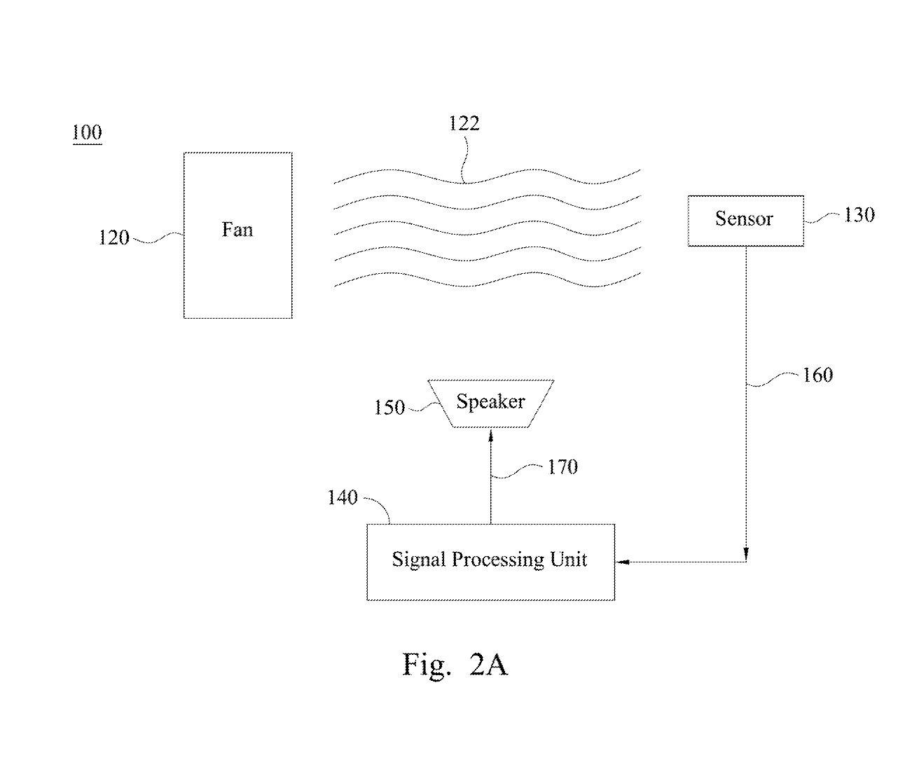

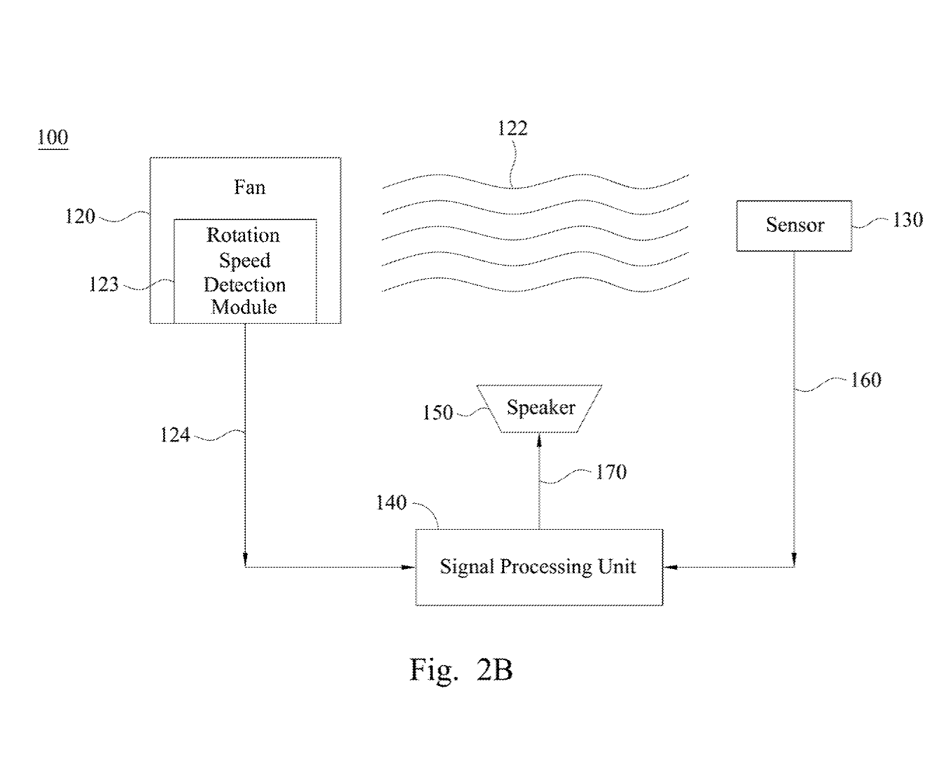

FIG. 2A is a block diagram of the system according to one embodiment of this invention. As shown in FIG. 1 and FIG. 2A, the system 100 includes a fin 110, a fan 120, a sensor 130, a signal processing unit 140, and a speaker 150. The fin 110 has a front side 111 and a rear side 112 opposite to the front side 111. The fan 120 is disposed adjacent to the front side 111 and has an airflow outlet 121, and the airflow outlet 121 faces the front side 111. The sensor 130 is disposed adjacent to the rear side 112 and is used for receiving a sound signal 160 made by the fan 120. The signal processing unit 140 receives the sound signal 160 sent by the sensor 130 and analyzes the sound signal 160 to compute an inversed phase signal 170. The speaker 150 is disposed adjacent to the rear side 112 and is used for receiving and outputting the inversed phase signal 170 provided by the signal processing unit 140, so as to offset the noise made by the fan 120.

The system 100 is mainly used for eliminating low-frequency noises. When blades of the fan 120 are rotating and generating airflow 122, the airflow 122 may become inhomogeneous in time series due to the rotation of the blades, and the inhomogeneous airflow 122 forms a low and single frequency noise, or so called blade passing tone. The system 100 adopts active noise cancellation to eliminate fan noise. In other words, the method eliminates noises by emitting another sound to cancel out the noises.

The system 100 uses a secondary sound source to generate an offsetting sound 151 to offset the noise made by the fan 120 and to achieve noise control. Specifically, as show in FIG. 2A, after the sensor 130 receives the sound signal 160 made by the fan 120, the sensor 130 sends the sound signal 160 to the signal processing unit 140. After the sound signal 160 is received by the signal processing unit 140, the signal processing unit 140 performs analysis and computation to obtain an inversed phase signal 170 with a same magnitude but opposite phase of the sound signal 160, and the signal processing unit 140 sends the inversed phase signal 170 to the speaker 150 and command the speaker 150 to outputting the inversed phase signal 170. Hence, the speaker 150 emits the offsetting sound 151 according to the inversed phase signal 170. The offsetting sound 151 emitted by the speaker 150 may cancel out the fan noise, so as to achieve noise control.

The sound signal 160 can be a mixed signal of a sound made by the fan 120 and a sound made by the speaker 150. Specifically, after the fan 120 starts operate, the speaker 150 does no make any sound, so the sound signal 160 received by the sensor 130 is the noise made by the fan 120. Then, the speaker 150 outputs the inversed phase signal 170 to offset the noise made by the fan 120. However, after the offsetting sound 151 emitted by the speaker 150 interferes with the noise made by the fan 120, the noise may not be cancelled out due to a calculation error or other error factors. At this time, the sensor 130 can receive the sound signal 160 again, and the sound signal 160 now is the mixed signal of the sound made by the fan 120 and the sound made by the speaker 150. After the signal processing unit 140 receives the sound signal 160 mixed by the sound made by the fan 120 and the sound made by the speaker 150, the signal processing unit 140 obtains a compensation signal with an opposite phase of the sound signal 160 by analysis and computation, and then the signal processing unit 140 obtains the new inversed phase signal 170 by adding the compensation signal and the previous inversed phase signal 170 together. Then the signal processing unit 140 commands the speaker 150 to output the new inversed phase signal 170 to offset the noise made by the fan 120. The above procedure can be repeated several times to achieve the best result. The time interval between every calculation of the inversed phase signal 170 can he shorter than one second, so the correction procedure can be completed quickly and the noise can be eliminated in a short time. Moreover, when characteristics of the fan noise changes due to a change of an external situation, for example, a rotation speed of the fan 120 changes due to a change of a temperature of a motherboard, the above operation procedure can make correction in accordance with external situations timely.

In order to make the condition possible that the sound signal 160 can be the mixed signal of the sound made by the fan 120 and the sound made by the speaker 150, a distance between the fan 120 and the sensor 130 is larger than a distance between the fan 120 and the speaker 150. Therefore, the noise made by the fan 120 interferes with the offsetting sound 151 first, and then the noise is received by the sensor 130. Specifically, as show in FIG. 1, the distance between the sensor 130 and the fin 110 is greater than the distance between the speaker 150 and the fin 110. In addition, the speaker 150 and the sensor 130 are separated, so the offsetting sound 151 emitted by the speaker 150 may not be directly received by the sensor 130. Instead, the offsetting sound 151 may interfere with the noise made by the fan 120 first, then the sound signal 160 is formed by thoroughly mixing the sound made by the fan 120 and the offsetting sound 151 made by the speaker 150, and then the sound signal 160 is received by the sensor 130.

The sensor 130 can be a microphone or other devices which are able to detect sound. People having ordinary skill in the art can make proper modification to the sensor 130 according to their actual needs.

The signal processing unit 140 can be a processor. People having ordinary skill in the art can make proper modification to the signal processing unit 140 according to their actual needs.

FIG. 2B is a block diagram of the system according to another embodiment of this invention. As shown in FIG. 2B, the fan 120 can have a rotation speed detection module 123 for providing the signal processing unit 140 a fan rotation speed signal 124 as a reference signal for analyzing and computing the inversed phase signal 170, The rotation speed detection module 123 can be a contact tachometer, a non-contact tachometer, or a stroboscope.

As shown in FIG. 1, the fin 110 can be columnar and can have a long edge, and the front side 111 and the rear side 112 are respectively disposed at both ends of the long edge. In addition to the inhomogeneous airflow 122 in time series due to the rotation of the blades, the airflow 122 may make noises because the airflow 122 is extruded or collided by neighboring devices. Specifically, noises may be made because the airflow 122 is extruded or collided by the fin 110. The aforementioned noises are made due to the flowing of the airflow 122, so the noises are transmitted mainly along with the flow direction of the airflow 122, that is, an airflow output direction A of the fan 120 Accordingly, the sensor 130 and the speaker 150 are disposed adjacent to the rear side 112, such that the sensor 130 is able to receive the fan noises n the airflow 122 leaving from the rear side 112 and that the speaker 150 is able to emit offsetting sound 151 to interfere and cancel out the fan noises in the airflow 122 leaving from the rear side 112.

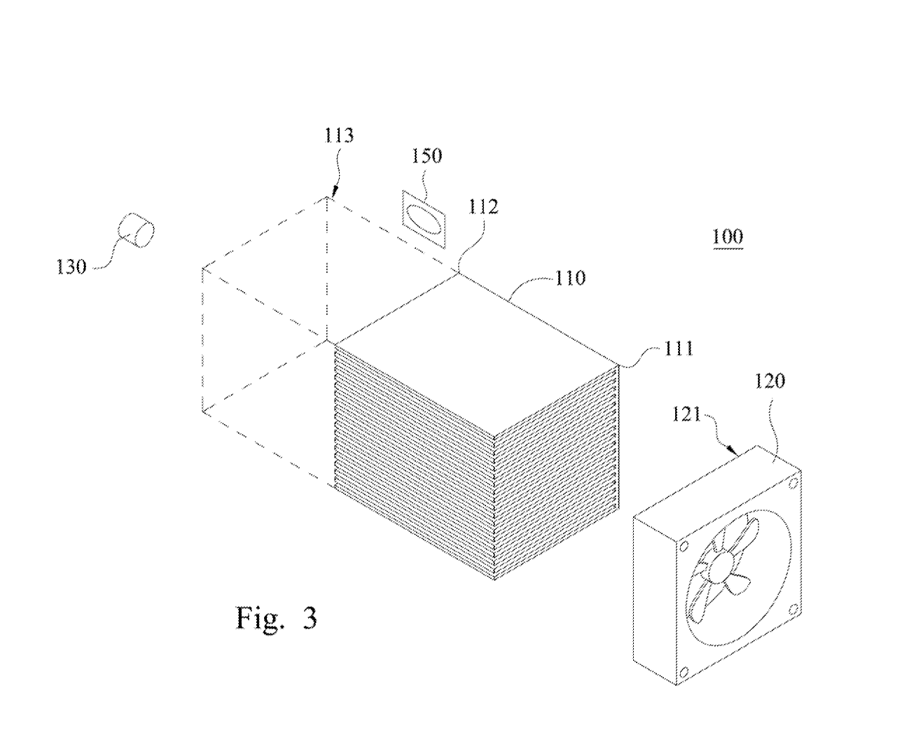

FIG. 3 is another perspective view of the system according to one embodiment of this invention. As shown in FIG. 1 and FIG. 3, the speaker 150 can be disposed outside an imaginary column 113 extended from the fin 110. The imaginary extending column 113 is an imaginary column extending along with the long edge of the fin 110. After the airflow 122 leaves the rear side 112, the airflow 122 is mainly distributed in the imaginary extending column 113, so disposing the speaker 150 outside the imaginary column 113 can avoid the situation that the airflow 122 is blocked and thus that the heat-dissipating performance is lowered. In addition, the speaker 150 can output the inversed phase signal 170 along a sound direction S, and disposing the speaker 150 outside the imaginary column 113 makes the speaker 150 easily aims the fan noises moving along with the airflow 122, so that the offsetting sound 155 can easily interfere with the fan noises. The airflow output direction A can be perpendicular to the sound direction S, or the angle between the airflow output direction A and the sound direction S can be any degree.

The speaker 150 can neighbor the rear side 112. Almost all of the airflow 122 moves along with the airflow output direction A in the fin 110, and some of the airflow 122 may diffuse in different directions after the airflow 122 leaves from the rear side 112. In order to make the offsetting sound 155 interferes with almost all of the fan noises, disposing the speaker 150 neighboring the rear side 122 can make the speaker 150 emit offsetting sound 151 to interfere the fan noises before the fan noises diffuse with the airflow 122.

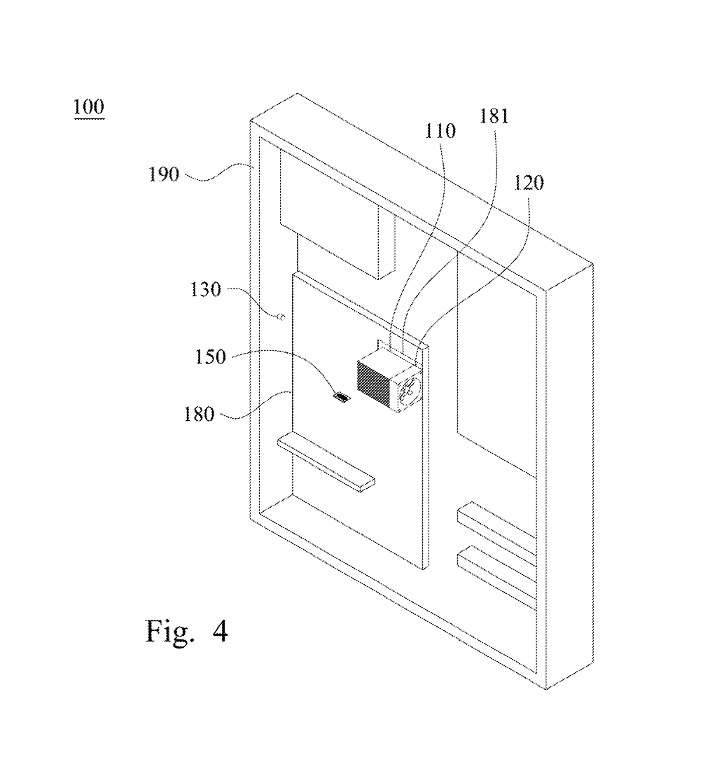

FIG. 4 is a perspective view of the system installed in a personal computer according to one embodiment of this invention. As shown in FIG. 1 and FIG. 4. The system 100 can further include a motherboard 180. The motherboard 180 can have a central processing unit 181, and the fin 110 thermally contacts with the central processing unit 181. Therefore, the central processing unit 181 can first dissipate heat to the fin 110, and then the fan 120 generates the airflow 122, which contacts with the fin 110 and takes away the heat in the fin 110, so as to effectively cool the central processing unit 181. The signal processing unit 140 can be a software or a firmware installed in the motherboard 180. The system 100 can further include a case 190, and the sensor 130 is disposed on the case 190.

By properly designing the relative positions of the fin 110, the fan 120, the sensor 130, and the speaker 150, the fan 120 can effectively dissipate the heat generated by the central processing unit 181 through the fin 110. In the meantime, because the fin 110 guides the airflow 122 and the noise, the sensor 130 and the speaker 150 are disposed adjacent to the rear side 112 of the fin 110, which is the leeward side, so that the system 100 can effectively eliminates the noises made by the fan 120.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A system for controlling fan noise, comprising:
a fin with a front side and a rear side opposite to each other;
a fan disposed adjacent to the front side and having an airflow outlet, wherein the airflow outlet faces the front side;
a sensor disposed adjacent to the rear side for receiving a sound signal made by the fan;
a signal processing unit for receiving the sound signal sent by the sensor and analyzing the sound signal to compute an inversed phase signal; and
a speaker disposed adjacent to the rear side for receiving and outputting the inversed phase signal provided by the signal processing unit to offset a noise made by the fan.

2. The system of claim 1, wherein a distance between the fan and the sensor is larger than a distance between the fan and the speaker.

3. The system of claim 1, wherein a distance between the sensor and the fin is larger than a distance between the speaker and the fin.

4. The system of claim 1, wherein the sound signal is a mixed signal of a sound made by the fan and a sound made by the speaker.

5. The system of claim 4, wherein the speaker and the sensor are separated to assure that the mixed signal is thoroughly mixed by the sound made by the fan and the sound made by the speaker.

6. The system of claim 1, wherein the fin is columnar and has a long edge, and the front side and the rear side are respectively disposed at both ends of the long edge.

7. The system of claim 6, wherein the speaker is disposed outside an imaginary column extended from the fin, and the speaker neighbors the rear side.

8. The system of claim 7, wherein the fan outputs an airflow along an airflow output direction, the speaker outputs the inversed phase signal along a sound direction, and the airflow output direction is perpendicular to the sound direction.

9. The system of claim 1, further comprising a motherboard, wherein the motherboard has a central processing unit, the fin thermally contacts with the central processing unit.

10. The system of claim 1, wherein the fan has a rotation speed detection module for providing the signal processing unit a fan rotation speed signal as a reference signal for analyzing and computing the inversed phase signal.
